(19) United States
(12) Patent Application Publication
(10) Pub. No.: US 2016/0328934 A1
(43) Pub. Date: Nov. 10, 2016

(54) OIL AND GAS PRODUCTION FACILITY EMISSIONS SENSING AND ALERTING DEVICE, SYSTEM AND METHOD

(71) Applicant: Mountain Optech, Inc. d/b/a Mountain Secure Systems, Longmont, CO (US)

(72) Inventors: Gregory P. Cenac, Estes Park, CO (US); Paul Brieser, Fort Collins, CO (US); Nick Cunningham, Longmont, CO (US); Bill McClintock, Boulder, CO (US); David Burke, Rockledge, FL (US); Mark Dixon, Golden, CO (US)

(21) Appl. No.: 15/188,536

(22) Filed: Jun. 21, 2016

Related U.S. Application Data
(63) Continuation of application No. 15/146,514, filed on May 4, 2016.
(60) Provisional application No. 62/156,595, filed on May 4, 2015.

(51) Int. Cl. G08B 17/10; G01N 15/06; G01M 15/10; E21B 43/26

(52) U.S. Cl. CPC G08B 17/10; E21B 43/26; G01N 15/0656; G01M 15/102; G01N 2015/0046

(57) ABSTRACT

A sensing and reporting device comprising an exhaust receiving section, an exhaust analyzing instrument, and a control unit. The exhaust receiving section comprises an exhaust sample intake port and a sampling line. The exhaust analyzing instrument comprises one or more sensors adapted to detect at least incomplete combustion and/or visible emissions in an enclosed combustion device. The exhaust analyzing instrument further comprises a probe chamber and a sampling block, with the sampling block comprising a sampling line inlet, a primary gas inlet, and an exhaust outlet. The control unit communicatively coupled to the exhaust analyzing instrument and emits a signal related to the detection of the incomplete combustion and/or visible emissions in the enclosed combustion device.

### PRIORITY

This application is a continuation of U.S. application Ser. No. 15/146,514, filed May 4, 2016 and entitled “Oil and Gas Production Facility Emissions Sensing and Alerting Device, System, and Method.” U.S. application Ser. No. 15/146,514 claims priority to U.S. Provisional Application No. 62/156,595, filed May 4, 2015 and entitled “Oil and Gas Production Facility Emission Sensing and Alerting Device, System, and Method.” Both applications are incorporated herein by reference in their entirety.

### FIELD OF THE DISCLOSURE

The present disclosure relates to the oil and gas industry. In particular, but not by way of limitation, the present disclosure relates to providing early detection of visible emissions from an oil and gas well enclosed combustion device (“ECD”).

### BACKGROUND OF THE INVENTION

Hydraulic fracturing (“fracking”) is an oil and gas extraction technique that has seen an extraordinary increase in use during the last decade. During fracking, underground rock is fractured through the introduction of a highly-pressurized mixture of water, chemicals, and sand. The oil and gas within the rock is then released to the ground through the rock fractures. With the increased use of fracking methods to extract oil and gas, concern over how fracking affects the surrounding environment has increased as well. Such concern has led to federal, state, and local regulatory efforts to stem the release of emissions from production facility sites. For example, oil and gas operators may be fined for visible emissions, aka black smoke, emitted from an emission control device. Currently, the only visible emission detection process used by oil and gas operators comprises employing visual inspection of well sites.

### SUMMARY OF THE INVENTION

In order to limit visible emissions from a production facility site, a device has been developed to sense and report when visible emissions occur from combustors. One such device comprises a sensing and reporting device. One sensing and reporting device comprises an exhaust receiving section, an exhaust analyzing instrument, and a control unit. One exhaust receiving section comprises an exhaust sample intake port and a sampling line one of coupled and integrated to the sampling line intake port. The exhaust analyzing instrument may be one of coupled and integrated to the sampling line. The exhaust analyzing instrument may comprise a housing and one or more sensors coupled to the housing, with the one or more sensors able to detect whether the exhaust received by the exhaust sample intake port comprises incomplete combustion and/or visible emissions. The instrument may further comprise at least one probe chamber that is coupled to the one or more sensors and a sampling block one of coupled and integrated to the at least one probe chamber. The sampling block may comprise a sampling line inlet, a primary gas inlet, and an exhaust outlet. The control unit may be communicatively coupled to the exhaust analyzing instrument and the control unit may comprise a signal receiving portion for receiving first information from the exhaust analyzing instrument and a signal emitting portion for sending second information related to the first information.

Another embodiment of the invention comprises an oil and gas emission control system. One such system comprises the sensing and reporting device described in the previous embodiment, along with an enclosed combustion device stack and an automation system. The sensing and reporting device is coupled to the enclosed combustion device stack and is communicatively coupled to the automation system, which receives the second information.

Yet another embodiment of the invention comprises a method of obtaining a visible emission alert associated with an enclosed combustion device. One such method comprises obtaining an exhaust sample from the enclosed combustion device, measuring a particulate level in the exhaust sample, and providing a signal when the particulate level is above a designated threshold.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts a diagrammatic representation of a sensing a reporting device according to one embodiment of the invention;

FIG. 2 depicts one example of an exhaust receiving section according to one embodiment of the invention;

FIG. 3A depicts a diagrammatic representation of portions of a sensing a reporting device according to one embodiment of the invention;

FIG. 3B depicts portions of a sensing a reporting device according to one embodiment of the invention;

FIG. 4 depicts an exhaust sampling instrument according to one embodiment of the invention;

FIG. 5 depicts a method of obtaining a visible emission alert associated with an enclosed combustion device according to one embodiment of the invention; and

FIG. 6 depicts a diagrammatic representation of one embodiment of a computer system according to one embodiment of the invention.

### DETAILED DESCRIPTION

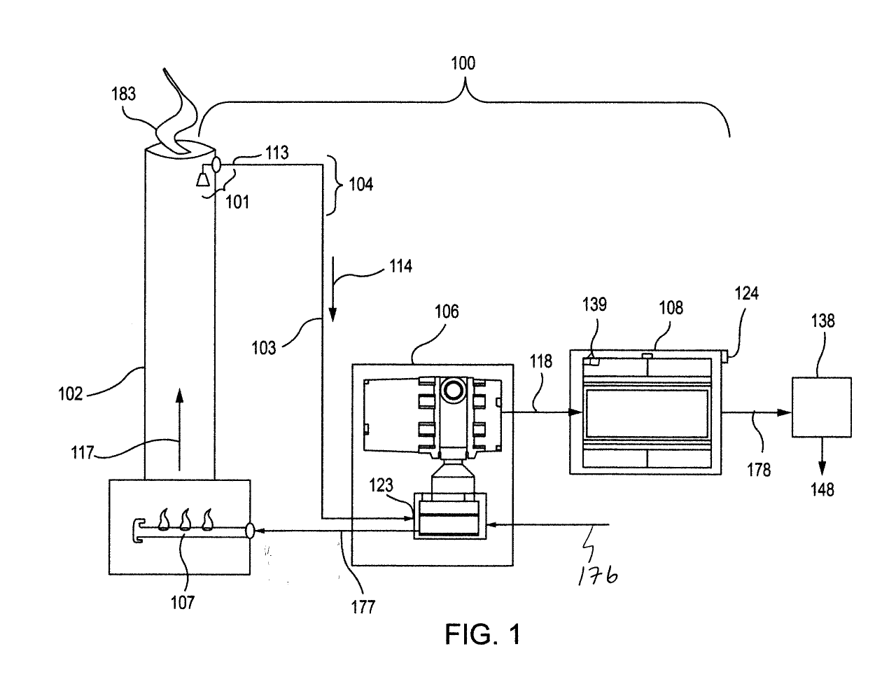

Turning first to FIG. 1, seen is one example of a sensing and reporting device 100. One such sensing and reporting device 100 may be located at an oil and/or gas facility and may be used to control emissions from storage tanks or other emission-producing systems. For example, as seen in FIG. 1, the sensing and reporting device 100 is coupled to, and adapted to monitor and provide an alert related to visible emissions emitted from an exit port 183 of an enclosed combustion device stack 102. The stack 102 may comprise an existing stack at an existing extraction site.

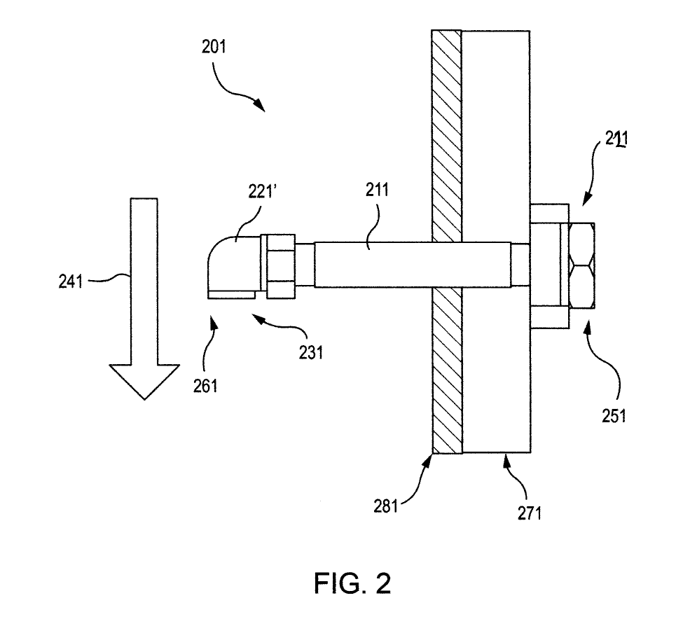

The sensing and reporting device 100 in FIG. 1 comprises an exhaust receiving section 104, an exhaust analyzing instrument 106, and a control unit 108. The exhaust receiving section 104 comprises an exhaust intake port 101 and a sampling line 103. FIG. 2 shows a close up of one example of the exhaust intake port 201. As seen the exhaust intake port 201 may comprise a pipe 211 and one or more pipe fittings 221 with a first of the one or more pipe fittings 221′ comprising an opening 231 pointing in a direction 241 that may comprise a direction 241 towards the ground and/or towards an enclosed combustion device stack burner 107, as seen in FIG. 1. The pipe 211 and all other piping described herein may conform to NPT standards and may comprise sizes varying from ¼″ to 2″ NPT. As seen in FIG. 2, the exhaust intake port 201 may extend from a first location 251 external to the ECD through a bore in the ECD sidewall 271 and insulation 281 to a second location 261 internal to the ECD. It is contemplated that the bore in the ECD sidewall 271 and insulation 281 may be located proximal to the exit port 183. As seen in FIG. 1, a first end 113 of the sampling line 103 may be coupled or integrated to the exhaust intake port 101, while a second end 123 may be coupled or integrated to the exhaust analyzing instrument 106. The term “coupled” and all similar terms as used herein refers to the connection of two separate and distinct objects, while the term “integrated” and all similar terms refers to a single, unitary object.

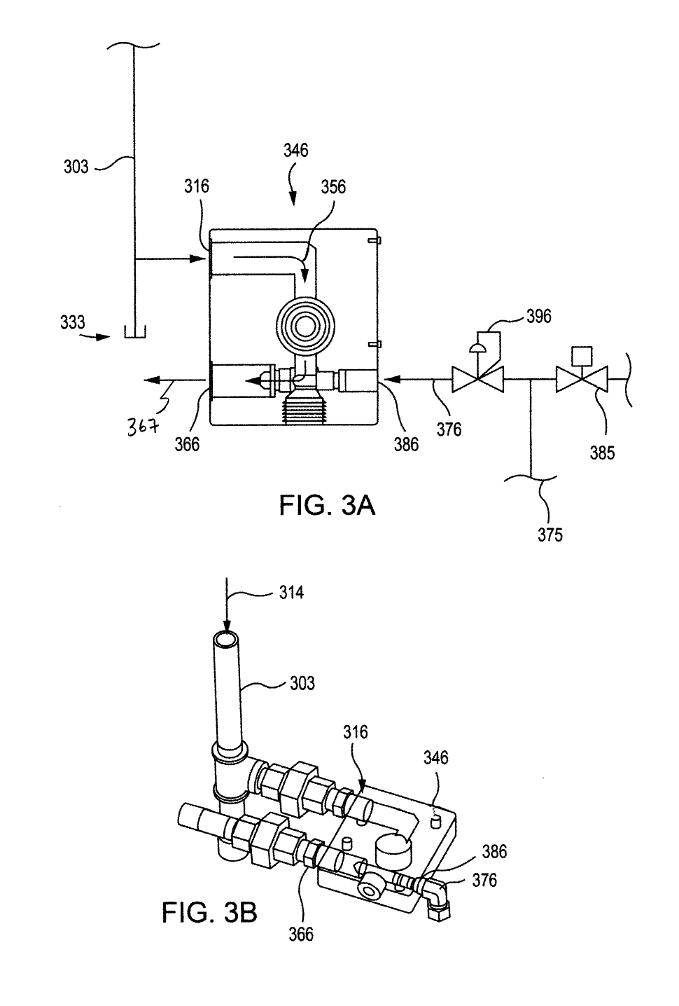

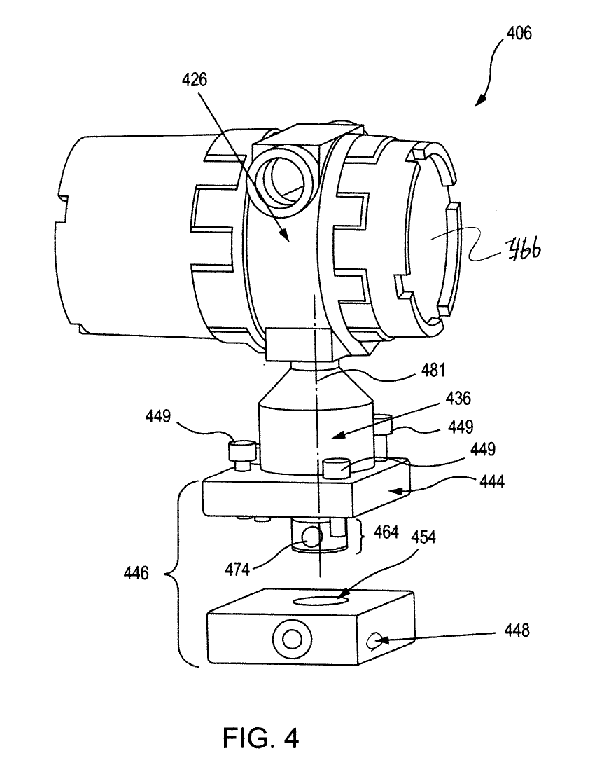

Turning now to FIG. 3A, seen is a portion of the sampling line 303 with a drip leg 333 and coupled to a sampling line inlet port 316 in a sampling block 346. As seen in FIG. 4, the sampling block 446 comprises a section of the exhaust analyzing instrument 406. For example, the exhaust analyzing instrument 406 may comprise an instrument housing 426, a probe chamber 436 coupled to the instrument housing 406 and a sampling block 446 coupled to the probe chamber 436. The sampling block 446 seen in FIG. 4 comprises a top section 444 and a bottom section 448. Coupled to and/or located within the housing 426 and/or probe chamber 436 may be one or more of the following sensors adapted to detect incomplete combustion or visible emissions within the exhaust sample received by the intake port 101 and sent to the instrument 406. Each of these sensors may implement an electrostatic charge sensing particulate measuring principle. However, other sensing types are also contemplated such as, but not limited to, accumulating electrode, radio frequency, light diffusion, through-beam, reflective, diffuse and optical sensing mechanisms. The sensors that may be implemented are particulate matter sensors a/k/a soot sensors; gas sensors for detecting carbon monoxide (CO), carbon dioxide (CO₂), nitrogen oxides (NO, NO₂, NO₃, etc.), hydrogen (H), methane (CH₄), and/or Oxygen (O₂); electro-optical or photoelectric sensors to detect black particulate matter in smoke; visible or infrared sensors; carbon detection sensors; and/or a generic hydrocarbon gas sensor (CxHx). In one embodiment, it is contemplated that a housing terminal side 426 faces the same direction as the primary gas inlet 386.

Returning now to FIGS. 1-3A and as also seen in FIG. 3B, as the exhaust from the burner 107 travels 117 up the stack 102, the exhaust enters the opening 231 and moves 114, 314 towards the inlet port 316. Upon entering the sampling block 346, the exhaust flows 356 towards the probe chamber 436, with a portion 464 of the probe chamber 436 being inserted and located in a sampling block bore 454. As the exhaust proceeds through a probe chamber bore 474, the exhaust analyzing instrument 406 detects a particulate matter level in the exhaust. It is contemplated that the exhaust analyzing instrument 406 may continuously sample the exhaust gas, for example, obtaining a measurement about every second. However, greater or lesser measurement amounts are contemplated—such as, but not limited to, one measurement every 1 s or one measurement every minute. As the exhaust exits the probe chamber bore 474, the exhaust continues towards, and exits the sampling block 346 through, an exhaust outlet 366. As seen in FIG. 1, the exhaust may proceed 177 to the enclosed combustion device stack 102 and enter the stack 102 proximal the enclosed combustion device stack burner 107. The exhaust may exit the sampling block 346 through piping 367 coupled to the exhaust outlet 366. It is contemplated that the probe chamber 436 may couple to a top section 444 of the sampling block 446 by, for example, a threaded coupling mechanism. The top section 444 may couple to the bottom section 448 by one or more threaded bolts 449 coupled to threaded bores in the top section 444 and the bottom section 448. As seen in FIG. 4, the probe chamber 436 may also comprise a longitudinal axis 481. It is contemplated that the longitudinal axis 481 is generally vertically-aligned during operation of the instrument 406 and that the instrument housing 426 is located at a vertically-higher location than the probe chamber 436, as seen in FIG. 4.

Returning now to FIGS. 3A and 3B, as seen a gas line 376 is coupled to a primary gas inlet 386 on the sampling block 346. Downstream from the sampling block 346, a pressure regulator 396 is coupled to the gas line 376 upstream of a pilot light 375 and a solenoid valve 385. The pressure regulator 396 is set so that the gas line 376 pressure enables the flow 356 of the exhaust from the exhaust intake port 201, through the sampling block 346 and to the enclosed combustion device stack 102. Gas line 376 pressure is preferably set from about 15 psi to about 60 psi, more preferably set from about 17.5 psi to about 35 pst and most preferably set from about 20 psi to about 25 psi. The gas line 376 may comprise ¼″ NPT in one embodiment, with the sampling line 103 and exhaust piping 367 comprising ½″ NPT. Upon entering the sampling block 346, the gas will also exit the sampling block 346 through the exhaust outlet 366 to the stack 102.

Returning now to FIG. 1, as the exhaust is monitored by the exhaust analyzing instrument 106, the exhaust analyzing instrument 106 may provide a signal to the control unit 108. One such control unit 108 may be adapted to receive a signal from ten separate exhaust analyzing instruments 106. In one embodiment, the exhaust analyzing instrument 106 may provide a first signal 118 to the control unit 108 when the exhaust analyzing instrument 106 has determined that the exhaust comprises a specified amount of visible emissions (i.e., black smoke) above a threshold level. For example, the first signal 118, that is continuously emitted from the instrument 106 to the control unit 108, may comprise a less than 5 nA (nanoAmp) signal while the instrument fails to detect a visible emissions. However, if visible emissions are detected, the first signal 118 may increase to about a 5 nA signal, or greater. In on embodiment, the 5nA signal may be emitted when the instrument determines that there is about 1-2 mg of soot per m³ of exhaust. However, other values are contemplated. The black smoke may comprise soot due to incomplete combustion in the enclosed combustion device stack 102. The first signal 118 may comprise first information and may be received by a signal receiving portion of the control unit 108 such as, but not limited to, a two-wire communication system, one wire comprising a positive (+) communication and one wire comprising a negative (−) communication. Therefore, to receive communications from a plurality of instruments 106, the control system 108 may comprise a plurality of communication port pairs 139. Other communication types are contemplated. Upon receiving the first signal 118 from the exhaust analyzing instrument 106, the control unit 108 may output a second signal 128. One second signal 128 may inform one or more automation systems 138 of the emission level in the exhaust. The second signal 128 may be emitted from a signal emitting portion of the control unit 108 and may comprise second information related to the first information. One such signal emitting portion may comprise a MODBUS RTU 2-wire, RS-485 output. However, like the first signal 118, other second signal 128 types known in the art are contemplated. In one embodiment, the second signal 128 may only be emitted when the first signal comprises 5 nA or greater. In alternative embodiments, like the first signal 118, the second signal 128 may be continuously emitted and may comprise a value that initiates an alert 148 when the second signal value comprises a threshold value. For example, the alert 148 may be sent when the second signal 128 comprises a 5 mA, or greater, signal. It is also contemplated that the automation system 138 and control unit 108 may comprise a single device. The automation system 138 may be configured to provide a real-time alert 148 regarding the visible emission level in the exhaust. For example, the automation system 138 may provide an email message to one or more designated email addresses or a text message to one or more designated telephone numbers. Other alerts 148 known in the art are also contemplated. Such alerts may enable oil and gas operators to avoid visible emission regulatory actions such as, but not limited to, fines. It is further contemplated that the control unit 108 may comprise a power receiving port 124 for receiving power from an external source.

It is contemplated that the alert 148 may only be issued after the second signal 128 informs the automation system 138 that the instrument 106 has found that visible emissions in the exhaust after a specified period of time. For example, a delay of four minutes may be set in the automation system 138 prior to issuing the alert 148 in order to prevent an alert 148 being issued based on an inaccurate reading. Greater or lesser delays such as, but not limited to, a delay of ten minutes or a delay of one minute may be implemented.

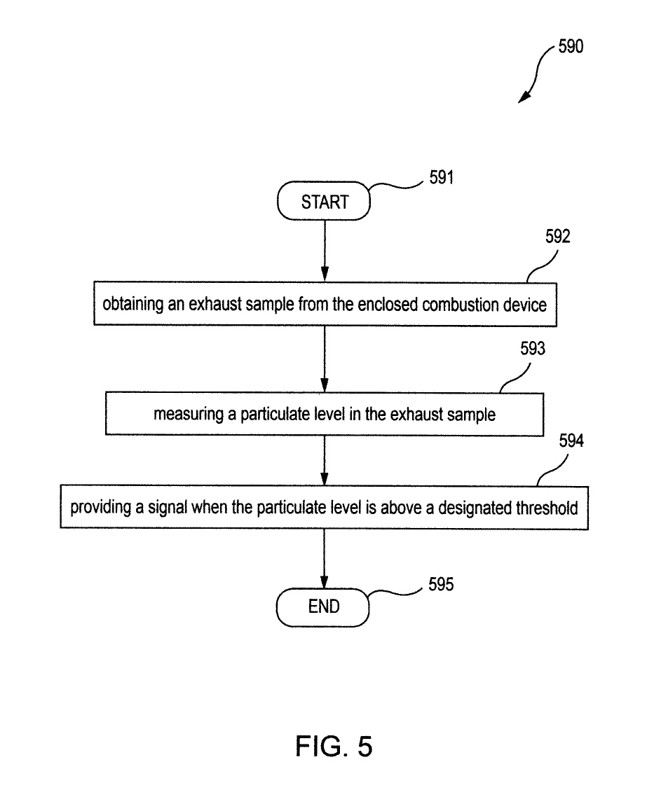

Turning now to FIG. 5, seen is one method 590 of obtaining a visible emission alert associated with an enclosed combustion device such as, but not limited to, the alert 148 and enclosed combustion device stack 102 described with reference to FIGS. 1-4. The method starts at 591 and at 592 comprises obtaining an exhaust sample from the enclosed combustion device. For example the exhaust sample may be obtained by employing the system described with reference to FIGS. 1-4. At 593 the method 590 comprises measuring a particulate level in the exhaust sample such as, by using the system described with reference to FIGS. 1-4. At step 594 the method 590 comprises providing a signal when the particulate level is above a designated threshold. For example, the first signal 118 and/or second signal 128 may be provided.

Although not seen in FIG. 5, in one method 590, obtaining an exhaust sample from the enclosed combustion device may comprise receiving the exhaust sample into an opening 231 of a pipe 211 with the opening 231 being located proximal the exit port 183. Additionally, measuring a particulate level in the exhaust sample may comprise connectively coupling the exhaust analyzing instrument 106 to the pipe 211 (e.g., through the sampling line 103) and coupling the gas line 176 to the exhaust analyzing instrument 106. The gas line pressure may be set through the pressure regulator 396 so that the gas line pressure creates a pressure difference between the pipe 211 and the exhaust analyzing instrument 106, and that pressure difference may enables the exhaust sample to flow to the exhaust analyzing instrument 106. Additional method 590 steps not shown in FIG. 5 may comprise exiting the exhaust sample and gas from the exhaust analyzing instrument 106 to the enclosed combustion device proximal an enclosed combustion device burner 107, for example, through piping 367 seen in FIG. 3.

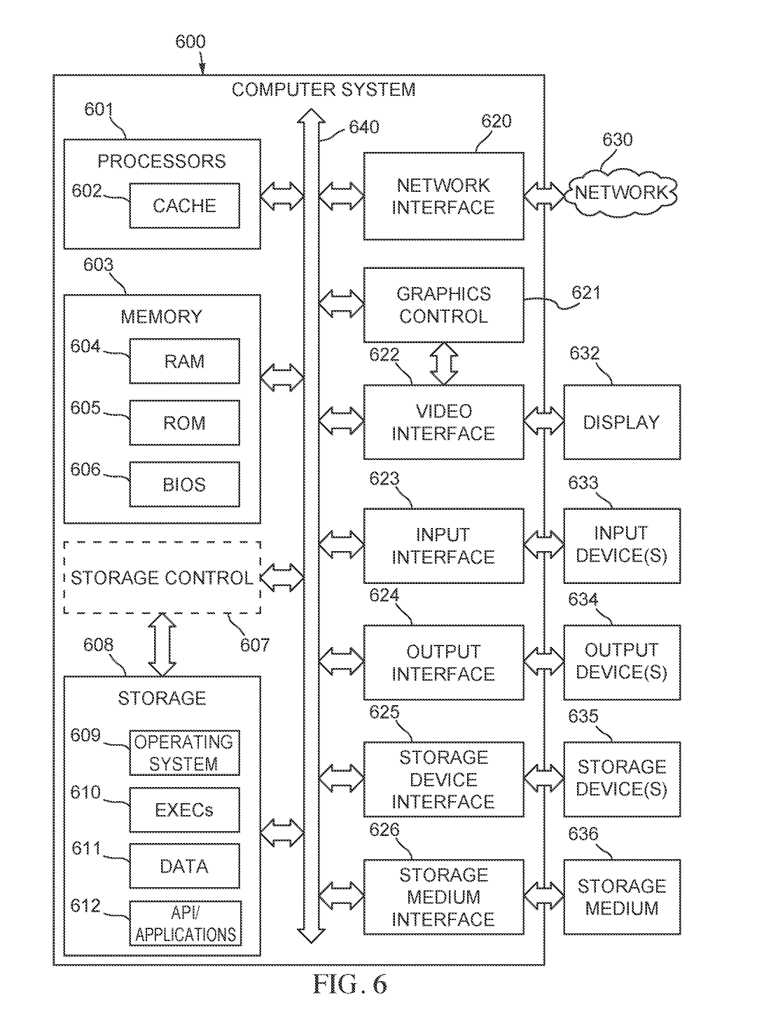

The readings from the instrument may be stored, analyzed, and modified in the automation system 138. The computing devices described herein may also be referred to as a computing system or a computer system. For example, FIG. 6 shows a diagrammatic representation of one embodiment of a computer system 600 within which a set of instructions can be executed to cause a device to store such readings and/or perform or execute any one or more of the aspects and/or methodologies of the present disclosure. The components in FIG. 6 are examples only and do not limit the scope of use or functionality of any hardware, software, firmware, embedded logic component, or a combination of two or more such components implementing particular embodiments of this disclosure. Some or all of the illustrated components can be part of the computer system 600. For instance, the computer system 600 can be a general purpose computer (e.g., a laptop computer) or an embedded logic device (e.g., an FPGA), to name just two non-limiting examples.

Computer system 600 includes at least one processor 601 such as a central processing unit (CPU) or an FPGA to name two non-limiting examples. Any of the subsystems described throughout this disclosure could embody the processor 601. The computer system 600 may also comprise a memory 603 and a storage 608, both communicating with each other, and with other components, via a bus 640. The bus 640 may also link a display 632, one or more input devices 633 (which may, for example, include a keypad, a keyboard, a mouse, a stylus, touch screen, etc.), one or more output devices 634, one or more storage devices 635, and various non-transitory, tangible computer-readable storage media/medium 636 with each other and with one or more of the processor 601, the memory 603, and the storage 608. All of these elements may interface directly or via one or more interfaces or adaptors to the bus 640. For instance, the various non-transitory, tangible computer-readable storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 601 (or central processing unit(s) (CPU(s))) optionally contains a cache memory unit 602 for temporary local storage of instructions, data, or computer addresses. Processor(s) 601 are configured to assist in execution of computer-readable instructions stored on at least one non-transitory, tangible computer-readable storage medium. Computer system 600 may provide functionality as a result of the processor(s) 601 executing software embodied in one or more non-transitory, tangible computer-readable storage media, such as memory 603, storage 608, storage devices 635, and/or storage medium 636 (e.g., read only memory (ROM)). For instance, instructions associated with at least a portion of the method 590 shown in FIG. 5 may be embodied in one or more non-transitory, tangible computer-readable storage media. The non-transitory, tangible computer-readable storage media (or medium) may store software comprising instructions that implements particular embodiments and processor(s) 601 may execute the software. Memory 603 may read the software from one or more other non-transitory, tangible computer-readable storage media (such as mass storage device(s) 635, 636) or from one or more other sources through a suitable interface, such as network interface 620. Any of the subsystems herein disclosed could include a network interface such as the network interface 620. The software may cause processor(s) 601 to carry out one or more processes or one or more steps of one or more processes described or illustrated herein. Carrying out such processes or steps may include defining data structures stored in memory 603 and modifying the data structures as directed by the software. In some embodiments, an FPGA can store instructions for carrying out functionality as described in this disclosure. In other embodiments, firmware includes instructions for carrying out functionality as described in this disclosure.

The memory 603 may include various components (e.g., non-transitory, tangible computer-readable storage media) including, but not limited to, a random access memory component (e.g., RAM 604) (e.g., a static RAM “SRAM”, a dynamic RAM “DRAM”, etc.), a read-only component (e.g., ROM 605), and any combinations thereof. ROM 605 may act to communicate data and instructions uni-directionally to processor(s) 601, and RAM 604 may act to communicate data and instructions bi-directionally with processor(s) 601. ROM 605 and RAM 604 may include any suitable non-transitory, tangible computer-readable storage media. In some instances, ROM 605 and RAM 604 include non-transitory, tangible computer-readable storage media for carrying out the method 590. In one example, a basic input/output system 606 (BIOS), including basic routines that help to transfer information between elements within computer system 600, such as during start-up, may be stored in the memory 603.

Fixed storage 608 is connected bi-directionally to processor(s) 601, optionally through storage control unit 607. Fixed storage 608 provides additional data storage capacity and may also include any suitable non-transitory, tangible computer-readable media described herein. Storage 608 may be used to store operating system 609, EXECs 610 (executables), data 611, API applications 612 (application programs/interfaces), and the like. Often, although not always, storage 608 is a secondary storage medium (such as a hard disk) that is slower than primary storage (e.g., memory 603). Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide nonvolatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, such as mobile devices and enterprise systems, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 630, may employ a wired and/or a wireless mode of communication. In general, any network topology may be used.

Information and data can be displayed through a display 632. Examples of a display 632 include, but are not limited to, a liquid crystal display (LCD), an organic liquid crystal display (OLED), a cathode ray tube (CRT), a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621.

In addition to a display 632, computer system 600 may include one or more other peripheral output devices 634 including, but not limited to, an audio speaker, a printer, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more steps of a method or algorithm described in connection with the embodiments disclosed herein (e.g., the method 590) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A sensing and reporting device comprising,
an exhaust receiving section comprising,
an exhaust sample intake port,
a sampling line one of coupled and integrated to the exhaust sample intake port;
an exhaust analyzing instrument one of coupled and integrated to the sampling line, wherein, the exhaust analyzing instrument comprises,
a housing,
one or more sensors coupled to the housing, wherein the one or more sensors detect at least one of,
incomplete combustion, and
visible emissions,
at least one probe chamber coupled to the housing,
a sampling block one of coupled and integrated to the at least one probe chamber, the sampling block comprising,
a sampling line inlet,
a primary gas inlet, and
an exhaust outlet; and
a control unit communicatively coupled to the exhaust analyzing instrument, the control unit comprising,
a signal receiving portion for receiving first information from the exhaust analyzing instrument, and
a signal emitting portion for sending second information related to the first information.

2. The sensing and reporting device of claim 1 wherein the one or more sensors obtain a measurement about every one second.

3. The sensing and reporting device of claim 1 wherein the first information comprises a notification signal of about 5 mA when the one or more sensors detect the presence of black smoke.

4. The sensing and reporting device of claim 3 wherein,
the 5 mA notification signal is emitted when the black smoke comprises about 1-2 mg of soot per cubic meter of exhaust; and
the one or more sensors employ an electro-static particulate measurement.

5. The sensing and reporting device of claim 3 wherein, the signal receiving portion receives first information for up to ten exhaust analyzing instruments.

6. The sensing and reporting device of claim 1 wherein,
the exhaust sample intake port comprises a pipe extending into an interior of an enclosed combustion device stack, the pipe comprising a pipe opening, the pipe opening facing an enclosed combustion device stack burner; and
the sampling line comprises a drip leg.

7. The sensing and reporting device of claim 6 wherein, the exhaust outlet is connectively coupled to the enclosed combustion device stack proximal the enclosed combustion device stack burner.

8. The sensing and reporting device of claim 1 wherein the control unit comprises,
a power receiving port; and
a plurality of communication port pairs, wherein each of the plurality of communication port pairs is communicatively coupled to one exhaust analyzing instrument.

9. An oil and gas emission control system comprising,
an enclosed combustion device stack;
a sensing and reporting device coupled to the enclosed combustion device stack, the sensing and reporting device comprising,
an exhaust receiving section comprising,
an exhaust sample intake port,
a sampling line one of coupled and integrated to the exhaust sample intake port,
an exhaust analyzing instrument one of coupled and integrated to the sampling line, wherein, the exhaust analyzing instrument comprises,
a housing,
one or more sensors coupled to the housing, wherein the one or more sensors detect at least one of,
incomplete combustion, and
visible emissions,
at least one probe chamber coupled to the one or more sensors, and
a sampling block one of coupled and integrated to the at least one probe chamber, the sampling block comprising,
a sampling line inlet,
a primary gas inlet, and
an exhaust outlet;
a control unit communicatively coupled to the exhaust analyzing instrument, the control unit comprising,
a signal receiving portion for receiving first information from the exhaust analyzing instrument, and
a signal emitting portion for sending second information related to the first information; and
an automation system communicatively coupled to the sensing and reporting device, the automation system receiving the second information.

10. The system of claim 9, wherein, the second information comprises information related to the at least one of incomplete combustion and visible emissions.

11. The system of claim 9 wherein,
the enclosed combustion device stack comprises an exit port and a burner;
the exhaust sample intake port is coupled to the enclosed combustion device stack proximal the exit port; and
the exhaust outlet is operatively coupled to the enclosed combustion device stack proximal the burner.

12. The system of claim 9 further comprising,
a gas line coupled to the primary gas inlet;
a pressure regulator coupled to the gas line; and
a solenoid valve coupled to the gas line.

13. The system of claim 9 wherein,
the at least one probe chamber comprises a longitudinal axis;
the longitudinal axis is generally vertically-aligned; and
the housing is located at a higher vertical location than the probe chamber.

14. A method of obtaining a visible emission alert associated with an enclosed combustion device, the method comprising,
obtaining an exhaust sample from the enclosed combustion device;
measuring a particulate level in the exhaust sample; and
providing an alert when the particulate level is above a designated threshold.

15. The method of claim 14 wherein,
the enclosed combustion device comprises an exit port; and
obtaining an exhaust sample from the enclosed combustion device comprises receiving the exhaust sample into an opening of a pipe, the opening being located proximal the exit port.

16. The method of claim 15 wherein, measuring a particulate level in the exhaust sample comprises, connectively coupling an exhaust analyzing instrument to the pipe;
coupling a gas line to the exhaust analyzing instrument;
setting a gas line pressure, wherein,
the gas line pressure creates a pressure difference between the pipe and the exhaust analyzing instrument, and
the pressure difference enables the exhaust sample to flow to the exhaust analyzing instrument;
flowing the gas to the exhaust analyzing instrument.

17. The method of claim 16 further comprising, exiting the exhaust sample and gas from the exhaust analyzing instrument to the enclosed combustion device proximal an enclosed combustion device burner.

18. The method of claim 15 wherein,
the enclosed combustion device comprises a burner; and
receiving the exhaust sample into a pipe opening located proximal the exit port comprises,
creating a bore in an enclosed combustion device stack,
inserting the pipe into the bore, and
facing the pipe opening towards the burner.

19. The method of claim 14 wherein, measuring a particulate level in the exhaust sample comprises, taking an electro-static particulate measurement about every second.

20. The method of claim 14 wherein, providing an alert when the particulate level is above a designated threshold comprises providing the alert when the exhaust analyzing instrument emits a signal of a least 5 nA.
